(19) United States
(12) Patent Application Publication
(10) Pub. No.: US 2007/0256718 A1
(43) Pub. Date: Nov. 8, 2007

(54) Mobility device

(76) Inventor: R. Gary Diaz, Highland Park, IL (US)

Correspondence Address: McKenna McGovern Burkhart, 134 North LaSalle Street, Suite 2040, CHICAGO, IL, 60602, US

(21) Appl. No.: 11/705,394

(22) Filed: Feb. 12, 2007

Related U.S. Application Data
(63) Continuation of application No. 11/218,354, filed on Sep. 2, 2005, now abandoned.

(51) Int. Cl. A61H 3/02

(52) U.S. Cl. 135/72

(57) ABSTRACT

A mobility device for enhancing movement of a user limited by illness or injury made from an elongated element with a plurality of longitudinally adjacent sections with a sloped forearm cradling section and a correspondingly sloped handgrip section which together align the hand with the forearm to ergonometrically support the body of the user and reduce muscular activity needed during ambulation and while stationary.

### BACKGROUND OF THE INVENTION

This invention relates to a mobility device for enhancing movement of a user limited by illness or injury which aligns the hand with the related forearm to reduce muscular activity needed during ambulation and which significantly improves the ergonomic grip when compared to all other devices for this purpose.. Moreover this invention provides the means for a healthcare professional to provide the necessary rehabilitation so the patient can return to a state of full functional activity. This device facilitates the treatment of anyone with a gait disorder; that is anyone with any limited ability to maintain balance and bear the load of the body's weight. Gait disorders have been treated with ambulatory devices including walkers, crutches and canes. These devices are limited in that they only provide for ambulation not rehabilitation. Moreover, these current art devices uses have deleterious affects. There has been an increase in the number of patients diagnosed with musculotendinous, neuropathic, or arthritic conditions of the arms as a result of repetitive trauma. Crutches, walking canes and other ambulatory devices have been implicated in worsening these conditions. The human who uses a cane hyperextends his wrist when weight bearing, causing a malaligned vector of force through the hand at the level of the metacarpal bones. This creates torque about the wrist joint. Walkers and crutches in use today do not allow an ergonomically correct grip and therefore they induce discomfort and possible injury. Crutches can be categorized into Axillary and Non-axillary crutches. Axillary crutches cause this problem at the points of contact under the arm and at the hand. Non-axillary crutches, also called Canadian or Lofstrand crutches, cause this problem at the hand and forearm contact points. This problem is especially acute in patients with blood circulation limitations, such as those caused by diabetes.

Any person who has temporarily required the use of a cane or crutch knows the discomfort involved. It is well documented that chronic cane or crutch use leads to repetitive stress disorders such as tendinitis, carpal tunnel syndrome, and osteoarthritis. Unfortunately, many people with arthritis are already at risk for these problems due to their inflamed joints. For patients with carpal tunnel syndrome, it has been shown that hyperflexion or extension of the wrist can lead to increased intracarpal wrist pressures. Moreover, problems with the circulatory system can be induced.

To alleviate these problems, and others which will become apparent from the disclosure which follows, the present invention conveniently aligns the hand with the forearm to reduce muscular activity needed during ambulation and while stationary. The mobility device preferably provides a forearm cradle positioned to support the forearm in its natural position while the hand is grasping a handgrip portion of the device. Both the forearm cradle and the handgrip are sloped to provide ergonometrically designed support to an upright user. Moreover the invention uses an offset section for ergonomic alignment. Moreover, the forearm support and handgrip create a pair of natural handholds that the user can use to assist him or her to stand up from a chair, bedside, sofa, wheelchair or similar object. Users with bad knees, weaker legs or other limitations can stand up easier with the present mobility device than by trying to balance themselves on canes, crutches, other ambulatory devices, or using surrounding furniture or other potentially unstable supports.

The angle between the hand grip and the vertical support is approximately 12 degrees negative from the perpendicular (of the vertical support) before the device's forearm cradle which is located at approximately a 24 degree positive angle from the vertical. Between the vertical support and the hand grip an offset section for ergonomic alignment is a key design feature.

A stabilizing advantage is made through the use of a bottom weighted mass element. The range of the preferred weight at the bottom tip varies with the size of the mobility device. At present we envision device sizes corresponding to the size of the user. In each case we expect that the mass at the end of the mobility device will be approximately 20 to 35% of the total mass of the device. The extra weight helps the user find a natural landing position.

The mobility device is designed for ergonometric use, ease of manufacturing, implicit quality and affordability. The following features are the key to manufacturing and quality using best practices in demand chain and supply chain technology and management. A one bend radius is used to create the entire shape. All different sizes of the mobility device are made on the same bending tools. Only four bends create the entire mobility device. This configuration simplifies and speeds up production.

Alternative technology is available in the form of U.S. Pat. No. 5,193,567 issued in 1993 to Razny, Jr. for a mobility enhancement device which discloses a cradle that wraps around the forearm of the user. The Razny, Jr. patent provides a horizontal hand grip and a horizontal cradle; in addition, there is an extended horizontal section 20 connecting the riser 18 to the horizontal cradle 22. The current invention eliminates this extended horizontal section 20 and provides a sloped cradle as well as a sloped handgrip. The sloped cradle and sloped handgrip provide improved body ergonometrics during both stationary and mobile use as they support an individual user in a different manner than that taught by Razny, Jr.

In addition, U.S. Pat. No. 5,331,989 issued to Stephens in 1994 for a walking aid having a forearm support that wraps around a user's forearm. Also see U.S. Pat. No. 5,860,439 issued in 1999 to Ostertag for a walking aid having a forearm supporting portion that wraps around the user's forearm. Also, U.S. Design Pat. No. 394,148 issued in 1998 to Hosick for a forearm crutch with a support piece and D440,396 issued in 2001 to Isaacson for a twisted cane having a bent handgrip.

The citation of the foregoing publications is not an admission that any particular publication constitutes prior art, or that any publication alone or in conjunction with others, renders unpatentable any pending claim of the present application. None of the cited publications is believed to detract from the patentability of the claimed invention.

The principal disadvantage of such devices is their lack of ergonometric compatibility with a human body requiring ambulatory support and their increased costs of manufacture.

### ADVANTAGES OF THIS INVENTION

Unlike the foregoing devices which teach structures that awkwardly support the body of a user, the mobility device provides an enabling capability to persons whose mobility has been limited by injury or illness. The mobility device transfers the force and stress to the forearm and additional portions of the body unlike a cane or a crutch. The mobility device provides the support and stability of a crutch without limiting mobility, and it provides the mobility and flexibility of a cane while relieving wrist fatigue and improving stability. Moreover the device serves as a rehabilitation aid so that with therapy and medical care the patient returns to full functional activities. The user experiences a secure feeling of support and it provides leverage when preparing to stand up and while standing.

The unique bends and shape of the mobility device make the support vector from the base of the cane pass into the body as described above. Between the vertical support and the hand grip an offset section for ergonomic alignment is a key design feature facilitating this support vector. The bottom end tip cover preferably includes an insertable mass equivalent to 20 to 35% of the mobility device mass so that the user can feel where the end of the mobility device is in space in relation to the floor, vastly improving safety and ergonomics. The bottom end tip cover provides traction and shock absorbency. The bottom end tip cover may be adapted to at least partially house an end tip light to facilitate use of the device in the dark. It is also specifically designed to facilitate the insertion of the mass element for enhanced ergonomic effects.

The mobility device handgrip is slightly sloped for easier grip and better stability and provides two support points (upper forearm support and lower handgrip) to assist users in standing up and sitting down. The handgrip and forearm support is slightly tilted up for safer and more comfortable support versus previous configurations. There is extra weight at the tip and tilted handgrip and forearm support so that the user always finds a safe natural position on the ground. This position is slightly in the front of the center of gravity of the user. The forearm support reaches near the elbow. Also, at this position the arm is in its natural ergonomic angle. The mobility device can easily be produced in different sizes for the length of forearm support.

This device allows for easier handling while turning. The fitted forearm support length requires less force to the handgrip resulting in less user fatigue. The device's height is fully adjustable. Different forearm lengths can be employed with height adjustability to provide a personally fitted mobility device. The mobility device provides the user with better dexterity due to its better fit to the user's personal body structure.

It is much easier to change handling by turning because the point of control is the wrist and the support goes to the forearm and then the shoulder. A cane has great flexibility but not much support because all the force goes through the wrist—a multi dimensional joint with weak strength. The crutch has great support through the shoulder but limited flexibility because it has essentially one degree of flexibility. The fitted mobility device reduces fatigue by significantly improving efficiency and thereby reducing wasted energy.

The forearm support and handgrip create a pair of natural handgrips that the user can use to assist the user to stand up from a chair, bedside, sofa, wheelchair, and other low level objects. This is particularly advantageous for users with bad knees, weaker legs or other limitations.

The mobility device provides these features and benefits with the weight of a conventional cane. The foam padded grip aids support to the wrist and arm and relieves pressure. An adjustable lock that makes it adjustable for the height is inherently secure and rattle free and can be adjusted to the user's height. One embodiment of the mobility device should accommodate users varying between 4 feet nine inches and 6 feet five inches.

These together with other objects of the invention, along with the various features of novelty which characterize the invention are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

Still other advantages will be apparent from the disclosure that follows.

### SUMMARY OF THE INVENTION

The invention relates to a mobility device for enhancing movement of a user limited by illness or injury. It comprises means for supporting the body of the user in an upright position that includes an elongated element having a first end and a second end and having a plurality of longitudinally adjacent sections located progressively along the length thereof proceeding from the first end to the second end; a forearm cradling section for supporting a portion of a forearm of the user which begins at the first end and extends away from an interior side of the forearm at the first end to an interconnecting section at an outside portion of the forearm, said forearm cradling section lies in a plane having a line normal thereto that is at a predetermined angle from vertical; the interconnecting section is substantially straight throughout a portion of its length, the interconnecting section extends from the forearm cradling section to a handgrip section, the interconnecting section extends generally along the length of the forearm from the outside portion of the forearm to a connecting location that is generally adjacent to a thumb side portion of a hand associated with the forearm when the thumb side portion of the hand is anterior to the palm section of the hand as the hand grips the handgrip section; the handgrip section is substantially straight throughout a portion of its length and extends downwardly from the interconnecting section to a base section; the handgrip section is located at an offset to the base section and the base section is substantially straight throughout a substantial portion of its length and extends from the handgrip section through the offset section to the second end of the elongated element.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWING

Preferred embodiments of the invention are described hereinafter with reference to the accompanying drawing wherein:

FIG. 1 is perspective view of the mobility device of the present invention with an arm shown in a position relative to the mobility device;

FIG. 2 is a side elevation of the mobility device of FIG. 1;

FIG. 3 is a front elevation of the mobility device of FIG. 1;

FIG. 4 is a two dimensional shaped developed view of the bends for the mobility device;

FIG. 5 is a fragmentary cutaway view of the mobility device with an extendible leg insertable within the second end of the hollow tube with a resilient tip cover disposed on the bottom end of the extendible leg;

FIG. 6 is an alternative view of the bottom end of the mobility device with the hollow tube inserted into the extendible leg;

FIGS. 7A-D show the method of making the mobility device from a hollow tube with a single radius of curvature bending apparatus with the initial bend starting at the first end of the mobility device and working toward the second end;

FIGS. 8A-D show a second method of making the mobility device from a hollow tube with a single radius of curvature bending apparatus with the initial bend starting proximate the second end of the mobility device and working toward the first end;

FIG. 9 is a cutaway perspective view of a lighted bottom end of the mobility device;

FIGS. 10A-B is an illustrative view of a user in a crouched position 10A grasping one of the handgrip section and the forearm cradling section with the right hand and the other of the handgrip section and the forearm cradling section with the left hand beginning to pull himself upwardly to an upright position 10B with the assistance of the mobility device;

FIG. 11 is a side elevation of the mobility device of the present invention with the resilient material comprising an elongated sleeve having an open end and a closed end covering the forearm cradling section, the interconnecting section, and the handgrip section; and

FIG. 12 is a front elevation of the mobility device of FIG. 11.

### DETAILED DESCRIPTION OF THE INVENTION

Without departing from the generality of the invention disclosed herein and without limiting the scope of the invention, the discussion that follows, will refer to the invention as depicted in the drawing.

The preferred embodiments of the apparatus depicted in the drawing comprise a mobility device 1 for enhancing movement of a user limited by illness or injury comprising means for supporting the body of the user in an upright position having an elongated element 2 having a first end 2a and a second end 2b and having a plurality of longitudinally adjacent sections located progressively along the length thereof proceeding from the first end 2a to the second end 2b, including a forearm cradling section 3 for supporting a portion of a forearm of the user which begins at the first end 2a and extends away from an interior side of the forearm at the first end 2a to an interconnecting section 4 at an outside portion of the forearm, the forearm cradling section 3 lies in a plane having a line normal thereto that is at a predetermined angle 5 from vertical. As shown in FIGS. 2 and 3, the interconnecting section 4 is offset from the vertical axis an angle A1 of approximately 24 degrees in a first direction, and an angle A2 of approximately 12 degrees in a second direction. These angular offests enhance the ergonometric and therapeutic functioning of the mobility device 1.

The interconnecting section 4 is substantially straight throughout a portion of its length, the interconnecting section 4 extends from the forearm cradling section 3 to a handgrip section 6, the interconnecting section 4 extends generally along the length of the forearm from the outside portion of the forearm to a connecting location that is generally adjacent to a thumb side portion of a hand associated with the forearm when the thumb side portion of the hand is anterior to the palm section of the hand as the hand grips the handgrip section 6. The handgrip section 6 is substantially straight throughout a portion of its length and extends downwardly from the interconnecting section 4 to a base section 7. The handgrip section 6 of the mobility device I may be padded with a resilient material.

The resilient material covering the handgrip section may comprise a hollow sleeve having a first open end and a second open end. The first open end and said second open end are suitably sized to slidably fit on to the first end of the mobility device so that the hollow sleeve can be slid past the forearm cradling section and the interconnecting section, and disposed on the handgrip section.

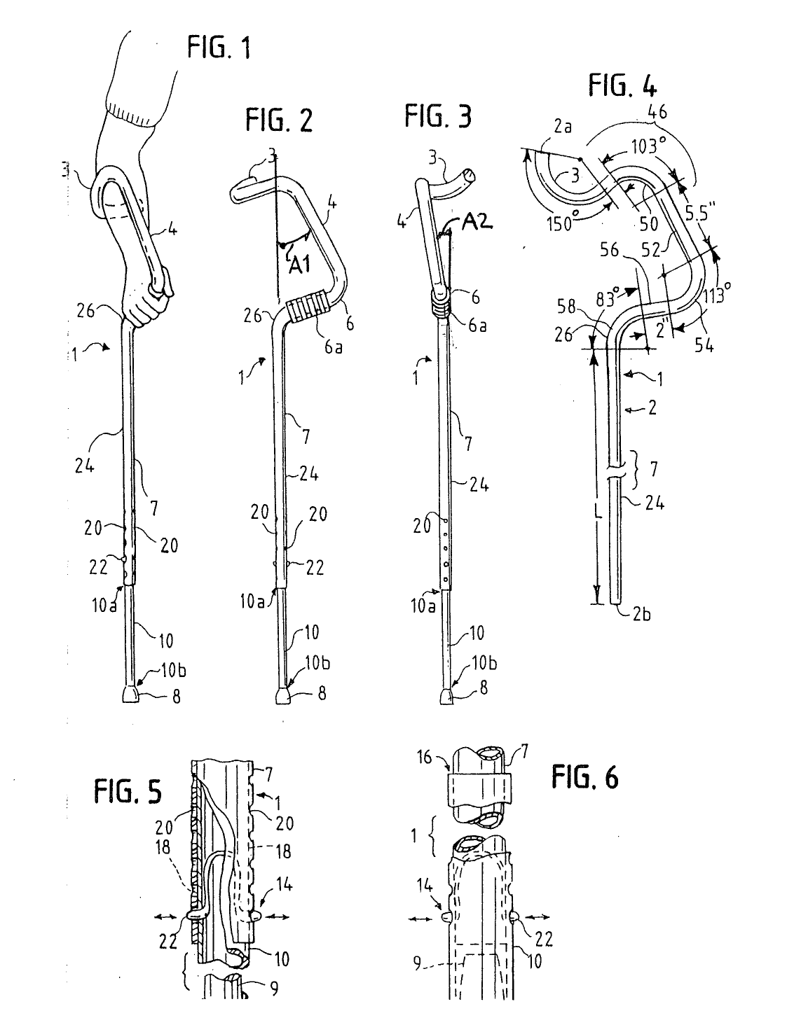

As shown in FIGS. 11 and 1, the forearm cradling section 3, the interconnecting section 4, and the handgrip section 6 may be padded with the resilient material. The resilient material covering the forearm cradling section, the interconnecting section, and the handgrip section may comprise an elongated sleeve having an open end and a closed end. The open end may be suitably sized to slidably fit on to the first end of the mobility device so that the elongated sleeve is disposed on the forearm cradling section, the interconnecting section, and the handgrip section. The base section 7 is substantially straight throughout a substantial portion of its length and extends from the handgrip section 6 to the second end 2b of the elongated element 2. At the second end 2b of the mobility device 1 a resilient tip cover 8 may be employed to soften contact with the ground. The resilient tip cover 8 may be disposed on the bottom end of the mobility device 1.

The mobility device 1 may comprise a light source for producing a light directed away from the bottom end of the mobility device 1. The light source may be powered by a power source, including a battery or a Michael Faraday magnet and coil arrangement to produce electricity. The light source and the power source being disposed in the bottom end of the mobility device 1. The resilient tip cover 8 may have a covering end adapted for engagement to one of the second end 2b and a bottom end of an extendible leg, and an exposed end adapted for engagement to the ground. The resilient tip cover 8 may be adapted for use with the light source with a first axial passageway for receiving one of the second end 2b and the bottom end of an extendible leg, and a second axial passageway for transmitting the light from the light source. One of the first axial passageway and the second axial passageway may be adapted to receive and secure a transparent means for protecting the light source.

The forearm cradling section 3 preferably lies in a plane having a line normal thereto that is approximately parallel to the longitudinal centerline of the user's forearm. By preference, the predetermined angle 5 is approximately seven degrees and more generally in the range of three to ten degrees.

The second end 2b of the base section 7 of the mobility device 1 may provide for grounding the mobility device 1 on which the body of the user is supported. Furthermore, the handgrip section 6 may extend downwardly at the predetermined angle 5 relative to a horizontal plane, whereby, the plane in which the forearm cradling section 3 lies is parallel to the substantially straight portion of the handgrip section 6. The handgrip section 6 can be wrapped with a padded grip 6a of foam or another resilient material. As can best be seen in FIG. 10, a user in a crouched position can grasp one of the handgrip section 6 and the forearm cradling section 3 with the right hand and the other of the handgrip section 6 and the forearm cradling section 3 with the left hand, and pull himself upwardly to an upright position with the assistance of the mobility device 1. Preferably, the base section 7 is disposed at the predetermined angle 5 from vertical where the handgrip section 6 and the forearm cradling section 3 are in different horizontal planes.

A mass element 9 may be disposed proximate to the second end 2b for stabilizing the mobility device 1. While a mass element 9 of any noticeable amount would help stabilize the mobility device 1, an end weight of between 20 and 35 percent of the weight of the entire mobility device 1 is preferred.

Preferably, the elongated element 2 comprises a machine malleable continuous tube. As shown in the drawing, the elongated element 2 is preferably a hollow tube with an outside diameter of approximately 0.75 inches. As best shown in FIG. 5, the mobility device 1 may include an extendible leg 10 and the hollow tube may have an opening 12 at the second end 2b for receiving the extendible leg 10. In such case, the extendible leg 10 has a proximal end 10a which is insertable into the opening 12 at the second end 2b of the hollow tube and a distal end 10b for grounding. Means for fastening 14 the second end 2b of the hollow tube to the extendible leg 10 may be provided as well.

For a mobility device 1 with an extendible leg, the mass element 9 can be disposed proximate to the distal end 10b of the extendible leg for stabilizing the mobility device 1. Preferably, the mass element 9 comprises between 20 to 35 percent of the entire weight of the mobility device 1. The extendible leg 10 may have a proximal end 10a. with a recess 16, as shown in FIG. 6, for receiving the second end 2b of the elongated element 2 and a distal end 10b for grounding the mobility device 1 on which the body of the user is supported, in which case proximate the second end 2b of the elongated element 2, means for fastening 14 the second end 2b of the elongated element 2 to the extendible leg 10 is provided.

This invention will supply features and benefits no other configurations now patented can provide affordably. When bending begins, a manufacturing operator can take a short precut pipe (approximately ¾ in inside diameter for the extendible leg) and inserts it in a machine to drill or punch a plurality of hole pairs. The distance between individual hole pairs varies from ¼ to ½ inch apart. After hole pairs are fabricated, the operator can insert the elongated element 2 in the hole pairs making machine to fabricate complementary hole pairs 20 for use with a detent button. Punching is preferred for affordability. After the elongated element 2 is bent and the hole pairs are fabricated, the operator slides a foam tube on the top part. The foam tube covers length of the elongated element 2 to cover the handgrip section 6. Then the operator inserts a hairpin spring detent button in the extendible leg 10 and inserts the combination into the opening 12 at the second end 2b of the elongated element 2, as shown in FIG. 5. The operator may then insert a mass element, such as lead, in the tip of the extendible leg 10. The operator slides a rubberized tip onto the same end of the extendible leg 10. A plastic o-ring may be inserted in the other side of the extendible leg 10.

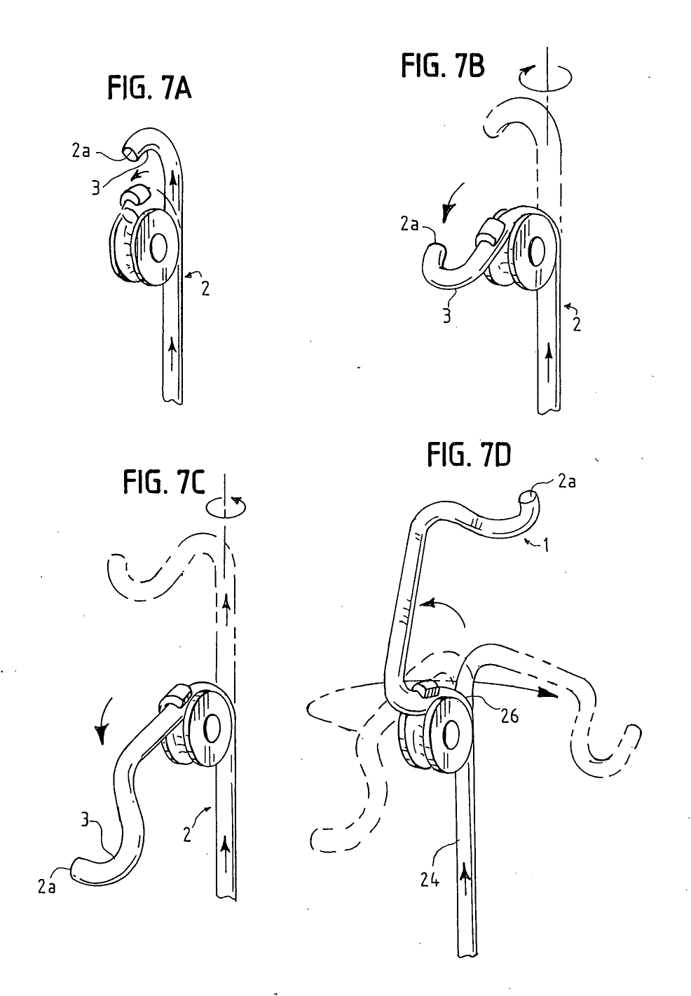

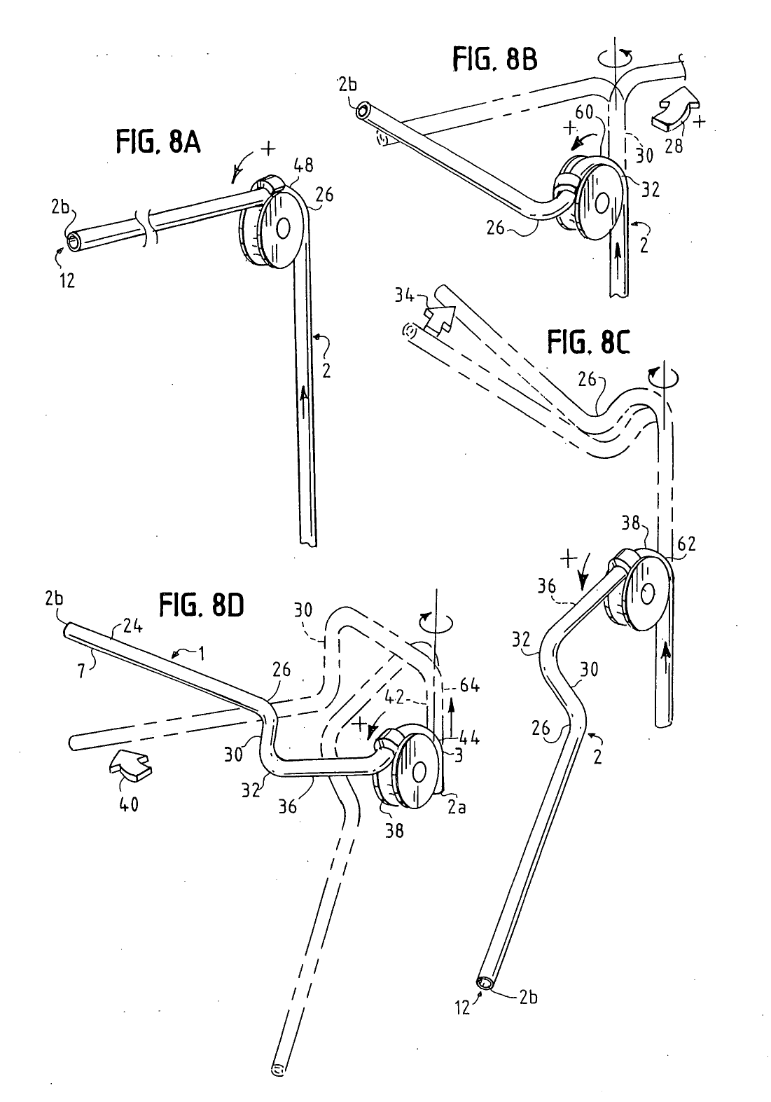

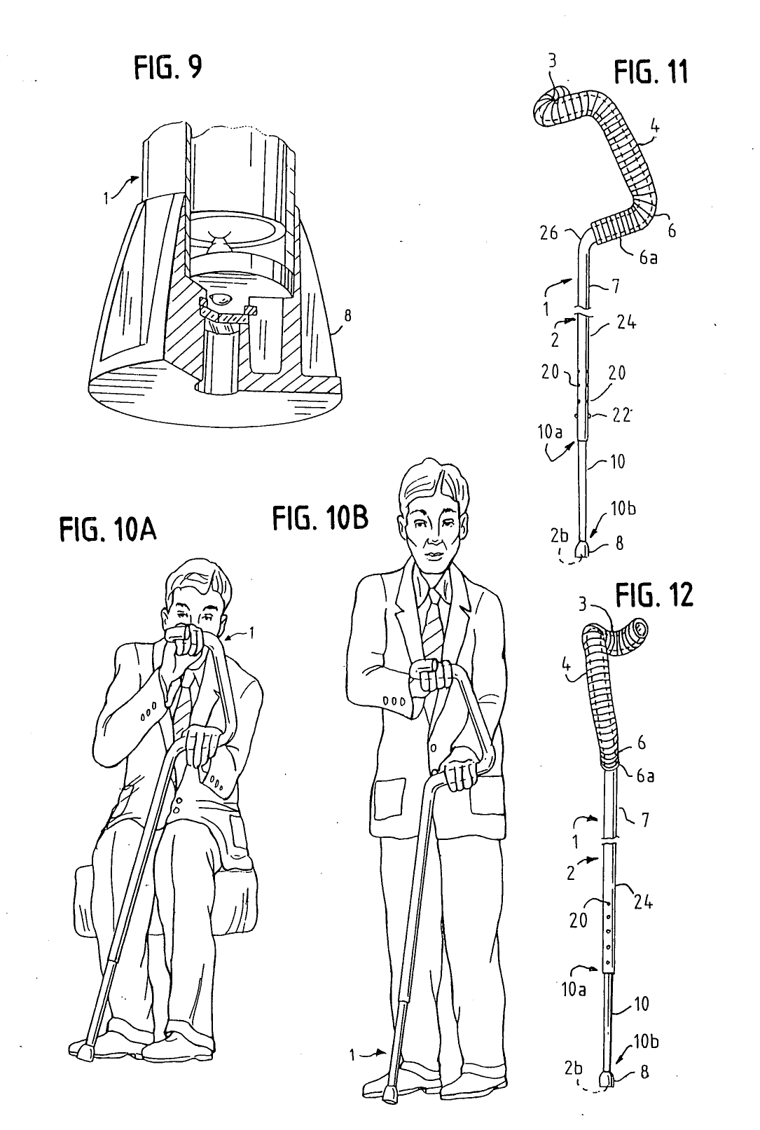

The bend angles and rotational angles of the mobility device 1 are best understood with reference to FIGS. 7 and 8. The following convention has been employed: the bend angles are stated in positive degrees for bends in a vertical plane made with a fixed bending machine, and each of the rotational angles is stated in positive degrees for counterclockwise rotation about a vertical axis of the elongated element 2 as viewed by an observer looking downwardly in the axial direction at a point where the elongated element 2 is tangent to a vertical wheel of the fixed bending machine. Rotational angles stated in negative degrees are for clockwise rotation.

Specifically, for a mobility device 1 with a plurality of longitudinally adjacent sections located progressively along the length thereof proceeding from the second end 2b to the first end 2a has a first straight section 24 of a first predetermined length, a first circular arc 26 comprising a bend angle of approximately 83 degrees with a predetermined radius of curvature, a first rotational angle of approximately 165 degrees followed by a generally straight second section 30 of a second predetermined length, a second circular arc 32 comprising a bend angle of approximately 113 degrees with the predetermined radius of curvature, a second rotational angle 34 of approximately negative 20 degrees followed by a generally straight third section 36 of a third predetermined length, a third circular arc 38 comprising a bend angle of approximately 103 degrees with the predetermined radius of curvature, a third rotational angle 40 of approximately negative 92 degrees followed by a generally straight fourth section 42 of a fourth predetermined length, and a fourth circular arc 44 comprising a bend angle of 150 degrees with the predetermined radius of curvature for the forearm cradling section 3 are provided.

The mobility device 1 may have the plurality of longitudinally adjacent sections located progressively along the length thereof proceeding from the second end 2b to the first end 2a and have a straight section of a predetermined length, with a first circular arc 26 comprising a bend angle of approximately 83 degrees with a predetermined radius of curvature, a first rotational angle 28 of approximately 165 degrees followed by a generally straight second section 30 of approximately 2 inches in length, a second circular arc 32 comprising a bend angle of approximately 113 degrees with the predetermined radius of curvature, a second rotational angle 34 of approximately negative 20 degrees followed by a generally straight third section 36 of approximately 5.5 inches in length (which can be increased or decreased to accommodate taller and shorter users), a third circular arc 38 comprising a bend angle of approximately 103 degrees with the predetermined radius of curvature, a third rotational angle 40 of approximately negative 92 degrees followed by a generally straight fourth section 42 of approximately 1 inch in length, and a fourth circular arc 44 comprising a bend angle of 150 degrees with the predetermined radius of curvature for the forearm cradling section 3. Preferably, the predetermined radius of curvature is about 1.75 inches.

Broadly stated, the mobility device 1 may have the plurality of longitudinally adjacent sections located progressively along the length thereof proceeding from the second end 2b to the first end 2a and have a first straight section of a first predetermined length, with a first circular arc 26 comprising a bend angle of approximately 83 degrees with a predetermined radius of curvature, a first rotational angle 28 in the range of 160-170 degrees followed by a generally straight second section 30 of a second predetermined length, a second circular arc 32 comprising a bend angle of approximately 113 degrees with the predetermined radius of curvature, a second rotational angle 34 in the range of negative 15-25 degrees followed by a generally straight third section 36 of a third predetermined length, a third circular arc 38 comprising a bend angle of approximately 103 degrees with the predetermined radius of curvature, a third rotational angle 40 of approximately negative 92 degrees followed by a generally straight fourth section 42 of a fourth predetermined length, and a fourth circular arc 44 comprising a bend angle of 150 degrees with the predetermined radius of curvature for the forearm cradling section 3.

The mobility device 1 by preference has a combined length of the first predetermined length and an extendible leg operably connected thereto in the range of 24-31 inches.

As shown in FIG. 8, the plurality of longitudinally adjacent sections located progressively along the length thereof proceeding from the second end 2b to the first end 2a has a first straight section of a predetermined length, includes a first circular arc 26 comprising a bend angle of approximately 83 degrees with a predetermined radius of curvature, a first rotational angle 28 in the range of 160-170 degrees followed by a generally straight second section 30 of approximately 2 inches in length, a second circular arc 32 comprising a bend angle of approximately 113 degrees with the predetermined radius of curvature, a second rotational angle 34 in the range of negative 15-25 degrees followed by a generally straight third section 36 of approximately 5.5 inches in length, a third circular arc 38 comprising a bend angle of approximately 103 degrees with the predetermined radius of curvature, a third rotational angle 40 of approximately negative 92 degrees followed by a generally straight fourth section 42 of approximately I inch in length, and a fourth circular arc 44 comprising a bend angle of 150 degrees with the predetermined radius of curvature for the forearm cradling section 3.

A preferred version of the mobility device 1 for enhancing movement of a user limited by illness or injury means for supporting the body of the user in an upright position, shown in FIGS. 7A-7D, is provided with an elongated element 2 having a first end 2a and a second end 2b and having a plurality of longitudinally adjacent sections located progressively along the length thereof proceeding from the first end 2a to the second end 2b; a forearm support section for supporting a portion of a forearm of the user which begins at the first end 2a and extends in an arc with a predetermined radius of curvature away from an interior side of the forearm at the first end 2a to a first transition section 46 at an outside portion of the forearm, the forearm support section (also identified as the forearm cradling section 3) lies in a plane having a line normal thereto that is at a predetermined angle 5 from vertical; said first transition section 46 comprises an initial straight section 48 followed by a first curved section 50, the first transition section 46 is disposed between the forearm support section 3 and a connecting section 52; said connecting section is substantially straight throughout a substantial portion of its length, the connecting section extends from the first transition section 46 to a handgrip section 6, the connecting section extends generally along the length of the forearm from the outside portion of the forearm to a connecting location that is generally adjacent to a thumb side portion of a hand associated with the forearm when the thumb side portion of hand is anterior to the palm section of the hand as the hand grips the handgrip section 6; said handgrip section 6 comprises a second curved section 54, a medial section 56 that is substantially straight throughout a substantial portion of its length, and a third curved section 58, the medial section 56 extends downwardly from the second curved section to the third curved section, and the third curved section extends to a base section 7; and said base section 7 is substantially straight throughout a substantial portion of its length and extends from the second curved section to the second end 2b of the elongated element 2.

Additionally, each of the first curved section, the second curved section and the third curved section may have the predetermined radius of curvature. As shown in FIG. 1, the base section 7 is typically vertically disposed during stationary support of the user.

An improved method of making a mobility device 1 from an elongated hollow tube having a first end 2a and the second end 2b is disclosed comprising the steps of:
a. at a predetermined distance from a second end 2b of an elongated straight hollow tube, inserting a primary section into a bending machine with a predetermined radius of curvature;
b. bending the primary section 48 into a first circular arc 26 comprising a bend angle of approximately 83 degrees;
c. releasing the hollow tube from the bending machine;
d. rotating the hollow tube through a first rotational angle 28 of approximately 165 degrees;
e. inserting a secondary section 60 that is approximately 2 inches from the primary section of the hollow tube into the bending machine with the predetermined radius of curvature;
f. bending the secondary section 60 into a second circular arc 32 comprising a bend angle of approximately 113 degrees with the bending machine with the predetermined radius of curvature;
g. releasing the hollow tube from the bending machine;
h. rotating the hollow tube through a second rotational angle 34 of approximately negative 20 degrees;
i. inserting a tertiary section 62 that is approximately 5.5 inches from the secondary section 60 of the hollow tube into the bending machine with the predetermined radius of curvature;

bending the tertiary section into a third circular arc 38 comprising a bend angle of approximately 103 degrees;
k. releasing the hollow tube from the bending machine;
l. rotating the hollow tube through a third rotational angle 40 of approximately negative 92 degrees;
m. inserting a quarternary section 64 that is approximately 1 inch from the tertiary section 62 of the hollow tube into the bending machine with the predetermined radius of curvature;
n. bending the quarternary section 64 into a fourth circular arc 44 comprising a bend angle of approximately 150 degrees; and
o. releasing the hollow tube from the bending machine.

Another improved method of making a mobility device 1 comprising the steps of:
a. inserting a quarternary section 64 proximate a first end 2a of an elongated straight hollow tube into a bending machine with a predetermined radius of curvature;
b. bending the quarternary section 64 into a fourth circular arc 44 comprising a bend angle of approximately 150 degrees;
c. releasing the hollow tube from the bending machine;
d. rotating the hollow tube through a third rotational angle 40 of approximately negative 92 degrees;
e. inserting a tertiary section 62 that is approximately 1 inch from the quarternary section 64 of the hollow tube into the bending machine with the predetermined radius of curvature;
f. bending the tertiary section 62 into a third circular arc 38 comprising a bend angle of approximately 103 degrees;
g. releasing the hollow tube from the bending machine;
h. rotating the hollow tube through a second rotational angle 34 of approximately negative 20 degrees;
i. inserting a secondary section 60 that is approximately 5.5 inches from the tertiary section 62 of the hollow tube into the bending machine with the predetermined radius of curvature;
j. bending the secondary section 60 into a second circular arc 32 comprising a bend angle of approximately 113 degrees;
k. releasing the hollow tube from the bending machine;
l. rotating the hollow tube through a first rotational angle 28 of approximately 165 degrees;
m. inserting a primary section that is approximately 2 inches from the secondary section 60 of the hollow tube into the bending machine with the predetermined radius of curvature;
n. bending the primary section 48 into a first circular arc comprising a bend angle of approximately 83 degrees; and
o. releasing the hollow tube from the bending machine.

Another improved method of making a mobility device includes the steps of:
p. inserting a quarternary section 64 proximate a first end of an elongated straight hollow tube into a bending machine with a predetermined radius of curvature;
q. bending said quarternary section 64 into a fourth circular arc comprising a bend angle of approximately 150 degrees;
r. releasing the hollow tube from the bending machine;
s. rotating the hollow tube through a third rotational angle of approximately negative 92 degrees;
t. inserting a tertiary section 62 that is approximately 1 inch from the quarternary section 64 of the hollow tube into the bending machine with the predetermined radius of curvature;
u. bending said tertiary section 62 into a third circular arc comprising a bend angle of approximately 103 degrees;
v. releasing the hollow tube from the bending machine;
w. rotating the hollow tube through a second rotational angle of in the range of negative 15-25 degrees;
x. inserting a secondary section 60 that is approximately 5.5 inches from the tertiary section 62 of the hollow tube into the bending machine with the predetermined radius of curvature;
y. bending said secondary section 60 into a second circular arc comprising a bend angle of approximately 113 degrees;
z. releasing the hollow tube from the bending machine;
aa. rotating the hollow tube through a first rotational angle of in the range of 160-170 degrees;
bb. inserting a primary section 48 that is approximately 2 inches from the secondary section 60 of the hollow tube into the bending machine with the predetermined radius of curvature;
cc. bending said primary section 48 into a first circular arc comprising a bend angle of approximately 83 degrees; and
dd. releasing the hollow tube from the bending machine.

The improved method of making the mobility device may include steps that proceed sequentially as follows:
a. inserting a quarternary section 64 proximate a first end of an elongated straight hollow tube into a bending machine with a predetermined radius of curvature;
b. bending said quarternary section 64 into a fourth circular arc comprising a bend angle of approximatelyl 50 degrees;
c. releasing the hollow tube from the bending machine;
d. one of rotating the hollow tube through a third rotational angle of approximately negative 92 degrees and inserting a tertiary section 62 that is approximately 1 inch from the quarternary section 64 of the hollow tube into the bending machine with the predetermined radius of curvature;
e. the other of rotating the hollow tube through a rotational angle of approximately negative 92 degrees and inserting the tertiary section 62 that is approximately 1 inch from the quarternary section 64 of the hollow tube into the bending machine with the predetermined radius of curvature;
f. bending said tertiary section 62 into a third circular arc comprising a bend angle of approximately 103 degrees;
g. releasing the hollow tube from the bending machine;
h. one of rotating the hollow tube through a second rotational angle of in the range of negative 15-25 degrees and inserting a secondary section 60 that is approximately 5.5 inches from the tertiary section 62 of the hollow tube into the bending machine with the predetermined radius of curvature;
i. the other of rotating the hollow tube through a second rotational angle of in the range of negative 15-25 degrees and inserting a secondary section 60 that is approximately 5.5 inches from the tertiary section 62 of the hollow tube into the bending machine with the predetermined radius of curvature;
j. bending said secondary section,60 into a second circular arc comprising a bend angle of approximately 113 degrees;
k. releasing the hollow tube from the bending machine;
l. one of rotating the hollow tube through a first rotational angle of in the range of 160-170 degrees and inserting a primary section 48 that is approximately 2 inches from the secondary section 60 of the hollow tube into the bending machine with the predetermined radius of curvature;
m. the other of rotating the hollow tube through a first rotational angle of in the range of 160-170 degrees and inserting the primary section 48 that is approximately 2 inches from the secondary section 60 of the hollow tube into the bending machine with the predetermined radius of curvature;
n. bending said primary section 48 into a first circular arc comprising a bend angle of approximately 83 degrees; and
o. releasing the hollow tube from the bending machine.

The improved method of making the mobility device 1 preferably requires that the predetermined radius of curvature is about 1.75 inches. The foregoing relate to a mobility device 1 for the right arm of the user. It will be readily understood by those skilled in the art that the mobility device 1 for the left arm is a mirror image of the one for the right arm. An example of a method of making such a mirror image left arm mobility device 1 from an elongated hollow tube having a first end 2a and the second end 2b, comprising the following steps of:
a. at a predetermined distance from a second end 2b of an elongated straight hollow tube, inserting a primary section 48 into a bending machine with a predetermined radius of curvature;
b. bending said primary section 48 into a first circular arc comprising a bend angle of approximately 83 degrees;
c. releasing the hollow tube from the bending machine;
d. rotating the hollow tube through a first rotational angle of approximately negative 165 degrees;
e. inserting a secondary section 60 that is approximately 2 inches from the primary section 48 of the hollow tube into the bending machine with the predetermined radius of curvature;
f. bending said secondary section 60 into a second circular arc comprising a bend angle of approximately 113 degrees with the bending machine with the predetermined radius of curvature;
g. releasing the hollow tube from the bending machine;
h. rotating the hollow tube through a second rotational angle of approximately negative 20 degrees;
i. inserting a tertiary section 62 that is approximately 5.5 inches from the secondary section 60 of the hollow tube into the bending machine with the predetermined radius of curvature;
j. bending said tertiary section 62 into a third circular arc comprising a bend angle of approximately 103 degrees;
k. releasing the hollow tube from the bending machine;
l. rotating the hollow tube through a third rotational angle of approximately 92 degrees;
m. inserting a quarternary section 64 that is approximately 1 inch from the tertiary section 62 of the hollow tube into the bending machine with the predetermined radius of curvature;
n. bending said quarternary section 64 into a fourth circular arc comprising a bend angle of approximately 150 degrees; and
o. releasing the hollow tube from the bending machine.

An example of an improved method of making a mobility device from an elongated hollow tube having a first end and the second end, comprising the steps of:
a. at a predetermined distance from a second end of an elongated straight hollow tube, inserting a primary section 48 into a bending machine with a predetermined radius of curvature;
b. bending said primary section 48 into a first circular arc comprising a bend angle of approximately 83 degrees;
c. releasing the hollow tube from the bending machine;
d. rotating the hollow tube through a first rotational angle of in the range of negative 160-170 degrees;
e. inserting a secondary section 60 that is approximately 2 inches from the primary section 48 of the hollow tube into the bending machine with the predetermined radius of curvature;
f. bending said secondary section 60 into a second circular arc comprising a bend angle of approximately 113 degrees with the bending machine with the predetermined radius of curvature;
g. releasing the hollow tube from the bending machine;
h. rotating the hollow tube through a second rotational angle in the range of negative 15-25 degrees;
i. inserting a tertiary section 62 that is approximately 5.5 inches from the secondary section 60 of the hollow tube into the bending machine with the predetermined radius of curvature;
j. bending said tertiary section 62 into a third circular arc comprising a bend angle of approximately 103 degrees;
k. releasing the hollow tube from the bending machine;
l. rotating the hollow tube through a third rotational angle of approximately 92 degrees;
m. inserting a quarternary section 64 that is approximately 1 inch from the tertiary section 62 of the hollow tube into the bending machine with the predetermined radius of curvature;
n. bending said quarternary section 64 into a fourth circular arc comprising a bend angle of approximately 150 degrees; and
o. releasing the hollow tube from the bending machine.

The improved method of making the mobility device may require that the steps proceed sequentially as follows:
a. at a predetermined distance from a second end of an elongated straight hollow tube, inserting a primary section 48 into a bending machine with a predetermined radius of curvature;
b. bending said primary section 48 into a first circular arc comprising a bend angle of approximately 83 degrees;
c. releasing the hollow tube from the bending machine;
d. one of rotating the hollow tube through a first rotational angle of in the range of negative 160-170 degrees and inserting a secondary section 60 that is approximately 2 inches from the primary section 48 of the hollow tube into the bending machine with the predetermined radius of curvature;
e. the other of rotating the hollow tube through a first rotational angle of in the range of negative 160-170 degrees and inserting a secondary section 60 that is approximately 2 inches from the primary section 48 of the hollow tube into the bending machine with the predetermined radius of curvature;
f. bending said secondary section 60 into a second circular arc comprising a bend angle of approximately 113 degrees with the bending machine with the predetermined radius of curvature;
g. releasing the hollow tube from the bending machine;
h. one of rotating the hollow tube through a second rotational angle of in the range of negative 15-25 degrees and inserting a tertiary section 62 that is approximately 5.5 inches from the secondary section 60 of the hollow tube into the bending machine with the predetermined radius of curvature;
i. the other of rotating the hollow tube through a second rotational angle of in the range of negative 15-25 degrees and inserting a tertiary section 62 that is approximately 5.5 inches from the secondary section 60 of the hollow tube into the bending machine with the predetermined radius of curvature;
j. bending said tertiary section 62 into a third circular arc comprising a bend angle of approximately 103 degrees;
k. releasing the hollow tube from the bending machine;
l. one of rotating the hollow tube through a third rotational angle of approximately 92 degrees and inserting a quarternary section 64 that is approximately 1 inch from the tertiary section 62 of the hollow tube into the bending machine with the predetermined radius of curvature;
m. the other of rotating the hollow tube through a third rotational angle of approximately negative 92 degrees and inserting the quarternary section 64 that is approximately 1 inch from the tertiary section 62 of the hollow tube into the bending machine with the predetermined radius of curvature;
n. bending said quarternary section 64 into a fourth circular arc comprising a bend angle of approximately 150 degrees; and
o. releasing the hollow tube from the bending machine.

Another improved method of making a mobility device comprises the steps of:
a. inserting a quarternary section 64 proximate a first end of an elongated straight hollow tube into a bending machine with a predetermined radius of curvature;
b. bending said quarternary section 64 into a fourth circular arc comprising a bend angle of approximately 150 degrees;
c. releasing the hollow tube from the bending machine;
d. rotating the hollow tube through a third rotational angle of approximately 92 degrees;
e. inserting a tertiary section 62 that is approximately 1 inch from the quarternary section 64 of the hollow tube into the bending machine with the predetermined radius of curvature;
f. bending said tertiary section 62 into a third circular arc comprising a bend angle of approximately 103 degrees;
g. releasing the hollow tube from the bending machine;
h. rotating the hollow tube through a second rotational angle of approximately negative 20 degrees;
i. inserting a secondary section 60 that is approximately 5.5 inches from the tertiary section 62 of the hollow tube into the bending machine with the predetermined radius of curvature;
j. bending said secondary section 60 into a second circular arc comprising a bend angle of approximately 113 degrees;
k. releasing the hollow tube from the bending machine;
l. rotating the hollow tube through a first rotational angle of approximately negative 165 degrees;
m. inserting a primary section 48 that is approximately 2 inches from the secondary section 60 of the hollow tube into the bending machine with the predetermined radius of curvature;
n. bending said primary section 48 into a first circular arc comprising a bend angle of approximately 83 degrees; and
o. releasing the hollow tube from the bending machine.

And another improved method of making a mobility device comprises the steps of:
a. inserting a quarternary section 64 proximate a first end of an elongated straight hollow tube into a bending machine with a predetermined radius of curvature;
b. bending said quarternary section 64 into a fourth circular arc comprising a bend angle of approximately 150 degrees;
c. releasing the hollow tube from the bending machine;
d. rotating the hollow tube through a third rotational angle of approximately 92 degrees;
e. inserting a tertiary section 62 that is approximately 1 inch from the quarternary section 64 of the hollow tube into the bending machine with the predetermined radius of curvature;
f. bending said tertiary section 62 into a third circular arc comprising a bend angle of approximately 103 degrees;
g. releasing the hollow tube from the bending machine;
h. rotating the hollow tube through a second rotational angle of in the range of negative 15-25 degrees;
i. inserting a secondary section 60 that is approximately 5.5 inches from the tertiary section 62 of the hollow tube into the bending machine with the predetermined radius of curvature;
j. bending said secondary section 60 into a second circular arc comprising a bend angle of approximately 113 degrees;
k. releasing the hollow tube from the bending machine;
l. rotating the hollow tube through a first rotational angle in the range of negative 160-170 degrees;
m. inserting a primary section 48 that is approximately 2 inches from the secondary section 60 of the hollow tube into the bending machine with the predetermined radius of curvature;
n. bending said primary section 48 into a first circular arc comprising a bend angle of approximately 83 degrees; and
o. releasing the hollow tube from the bending machine.

Additionally, the improved method of making the mobility device may require that the steps proceed sequentially as follows:
a. inserting a quarternary section 64 proximate a first end of an elongated straight hollow tube into a bending machine with a predetermined radius of curvature;
b. bending said quarternary section 64 into a fourth circular arc comprising a bend angle of approximately 150 degrees;
c. releasing the hollow tube from the bending machine;
d. one of rotating the hollow tube through a third rotational angle of approximately 92 degrees and inserting a tertiary section 62 that is approximately 1 inch from the quarternary section 64 of the hollow tube into the bending machine with the predetermined radius of curvature;
e. the other of rotating the hollow tube through a rotational angle of approximately negative 92 degrees and inserting the tertiary section 62 that is approximately 1 inch from the quarternary section 64 of the hollow tube into the bending machine with the predetermined radius of curvature;
f. bending said tertiary section 62 into a third circular arc comprising a bend angle of approximately 103 degrees;
g. releasing the hollow tube from the bending machine;
h. one of rotating the hollow tube through a second rotational angle of in the range of negative 15-25 degrees and inserting a secondary section 60 that is approximately 5.5 inches from the tertiary section 62 of the hollow tube into the bending machine with the predetermined radius of curvature;
i. the other of rotating the hollow tube through a second rotational angle in the range of negative 15-25 degrees and inserting a secondary section 60 that is approximately 5.5 inches from the tertiary section 62 of the hollow tube into the bending machine with the predetermined radius of curvature;
j. bending said secondary section 60 into a second circular arc comprising a bend angle of approximately 113 degrees;
k. releasing the hollow tube from the bending machine;
l. one of rotating the hollow tube through a first rotational angle of in the range of negative 160-170 degrees and inserting a primary section 48 that is approximately 2 inches from the secondary section 60 of the hollow tube into the bending machine with the predetermined radius of curvature;
m. the other of rotating the hollow tube through a first rotational angle of in the range of negative 160-170 degrees and inserting the primary section 48 that is approximately 2 inches from the secondary section of the hollow tube into the bending machine with the predetermined radius of curvature;
n. bending said primary section 48 into a first circular arc comprising a bend angle of approximately 83 degrees; and
o. releasing the hollow tube from the bending machine.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A mobility device for enhancing movement of a user limited by illness or injury comprising means for supporting the body of the user in an upright position having:
a. an elongated element having a first end and a second end and having a plurality of longitudinally adjacent sections located progressively along the length thereof proceeding from the first end to the second end;
b. a forearm cradling section for supporting a portion of a forearm of the user which begins at the first end and extends away from an interior side of the forearm at the first end to an interconnecting section at an outside portion of the forearm, said forearm cradling section lies in a plane having a line normal thereto that is at a predetermined angle from vertical;
c. said interconnecting section is substantially straight throughout a portion of its length, said interconnecting section extends from the forearm cradling section to a handgrip section, said interconnecting section extends generally along the length of the forearm from the outside portion of the forearm to a connecting location that is generally adjacent to a thumb side portion of a hand associated with the forearm when the thumb side portion of the hand is anterior to the palm section of the hand as the hand grips the handgrip section;
d. said handgrip section is substantially straight throughout a portion of its length and extends downwardly from the interconnecting section to a base section; and
e. said base section is substantially straight throughout a substantial portion of its length and extends from the handgrip section to the second end of the elongated element.

2. The mobility device of claim 1, wherein the second end of the base is provided for grounding the mobility device on which the body of the user is supported.

3. The mobility device of claim 1, wherein the handgrip section extends downwardly at the predetermined angle relative to a horizontal plane,
whereby, the plane in which the forearm cradling section lies is parallel to the substantially straight portion of the handgrip section.

4. The mobility device of claim 3, wherein the user in a crouched position can grasp one of the handgrip section and the forearm cradling section with the right hand and the other of the handgrip section and the forearm cradling section with the left hand, and pull himself upwardly to an upright position with the assistance of the mobility device.

5. The mobility device of claim 4, wherein the base section is disposed at the predetermined angle from vertical and the handgrip section and the forearm cradling section are in different horizontal planes.

6. The mobility device of claim 1, further comprising a mass element disposed proximate to the second end for stabilizing the mobility device.

7. The mobility device of claim 4, wherein the mass element comprises between 20 to 35 percent of the entire weight of the mobility device.

8. The mobility device of claim 1, wherein the elongated element comprises a machine malleable continuous tube.

9. The mobility device of claim 1, wherein the forearm cradling section lies in a plane having a line normal thereto that is approximately parallel to the longitudinal centerline of the user's forearm.

10. The mobility device of claim 1, wherein the predetermined angle is approximately seven degrees.

11. The mobility device of claim 1, wherein the predetermined angle is in the range of about three to 10 degrees.

12. The mobility device of claim 1, wherein the elongated element is a hollow tube.

13. The mobility device of claim 12, wherein the hollow tube has an outside diameter of approximately 0.75 inches.

14. The mobility device of claim 12, further comprising an extendible leg and wherein the hollow tube has an opening at the second end for receiving the extendible leg,
p.said extendible leg having a proximal end which is insertable into the opening at the second end of the hollow tube and a distal end for grounding.

15. The mobility device of claim 14, further comprising a mass element disposed proximate to the distal end of the extendible leg for stabilizing the mobility device.

16. The mobility device of claim 15, wherein the mass element comprises between 20 to 35 percent of the entire weight of the mobility device.

17. The mobility device of claim 14, further comprising a means for fastening the second end of the hollow tube to the extendible leg.

18. The mobility device of claim 1, further comprising an extendible leg, and wherein proximate the second end of the elongated element means for fastening the second end of the elongated element to the extendible leg is provided,
a. said extendible leg having a proximal end with a recess for receiving the second end of the elongated element and a distal end for grounding the mobility device on which the body of the user is supported.

19. The mobility device of claim 1, wherein the plurality of longitudinally adjacent sections located progressively along the length thereof proceeding from the second end to the first end have a first straight section of a first predetermined length, a first circular arc comprising a bend angle of approximately 83 degrees with a predetermined radius of curvature, a first rotational angle of approximately 165 degrees followed by a generally straight second section of a second predetermined length, a second circular arc comprising a bend angle of approximately 113 degrees with the predetermined radius of curvature, a second rotational angle of approximately negative 20 degrees followed by a generally straight third section of a third predetermined length, a third circular arc comprising a bend angle of approximately 103 degrees with the predetermined radius of curvature, a third rotational angle of approximately negative 92 degrees followed by a generally straight fourth section of a fourth predetermined length, and a fourth circular arc comprising a bend angle of 150 degrees with the predetermined radius of curvature for the forearm cradling section.

20. The mobility device of claim 1, wherein the plurality of longitudinally adjacent sections located progressively along the length thereof proceeding from the second end to the first end have a first straight section of a predetermined length, a first circular arc comprising a bend angle of approximately 83 degrees with a predetermined radius of curvature, a first rotational angle of approximately 165 degrees followed by a generally straight second section of approximately 2 inches in length, a second circular arc comprising a bend angle of approximately 113 degrees with the predetermined radius of curvature, a second rotational angle of approximately negative 20 degrees followed by a generally straight third section of approximately 5.5 inches in length, a third circular arc comprising a bend angle of approximately 103 degrees with the predetermined radius of curvature, a third rotational angle of approximately negative 92 degrees followed by a generally straight fourth section of approximately 1 inch in length, and a fourth circular arc comprising a bend angle of 150 degrees with the predetermined radius of curvature for the forearm cradling section.

21. The mobility device of claim 20, wherein the predetermined radius of curvature is about 1.75 inches.

22. The mobility device of claim 1, wherein the plurality of longitudinally adjacent sections located progressively along the length thereof proceeding from the second end to the first end has a first straight section of a first predetermined length, a first circular arc comprising a bend angle of approximately 83 degrees with a predetermined radius of curvature, a first rotational angle in the range of 160-170 degrees followed by a generally straight second section of a second predetermined length, a second circular arc comprising a bend angle of approximately 113 degrees with the predetermined radius of curvature, a second rotational angle in the range of negative 15-25 degrees followed by a generally straight third section of a third predetermined length, a third circular arc comprising a bend angle of approximately 103 degrees with the predetermined radius of curvature, a third rotational angle of approximately negative 92 degrees followed by a generally straight fourth section of a fourth predetermined length, and a fourth circular arc comprising a bend angle of 150 degrees with the predetermined radius of curvature for the forearm cradling section.

23. The mobility device of claim 22 wherein the combined length of the first predetermined length and an extendible leg operably connected thereto is in the range of 24-31 inches.

24. The mobility device of claim 1, wherein the plurality of longitudinally adjacent sections located progressively along the length thereof proceeding from the second end to the first end has a first straight section of a predetermined length, a first circular arc comprising a bend angle of approximately 83 degrees with a predetermined radius of curvature, a first rotational angle in the range of 160-170 degrees followed by a generally straight second section of approximately 2 inches in length, a second circular arc comprising a bend angle of approximately 113 degrees with the predetermined radius of curvature, a second rotational angle in the range of negative 15-25 degrees followed by a generally straight third section of approximately 5.5 inches in length, a third circular arc comprising a bend angle of approximately 103 degrees with the predetermined radius of curvature, a third rotational angle of approximately negative 92 degrees followed by a generally straight fourth section of approximately 1 inch in length, and a fourth circular arc comprising a bend angle of 150 degrees with the predetermined radius of curvature for the forearm cradling section.

25. A mobility device for enhancing movement of a user limited by illness or injury comprising means for supporting the body of the user in an upright position having:
a. an elongated element having a first end and a second end and having a plurality of longitudinally adjacent sections located progressively along the length thereof proceeding from the first end to the second end;
q.a forearm support section for supporting a portion of a forearm of the user which begins at the first end and extends in an arc with a predetermined radius of curvature away from an interior side of the forearm at the first end to a transition section at an outside portion of the forearm, said forearm support section lies in a plane having a line normal thereto that is at a predetermined angle from vertical;
r.said first transition section comprises an initial straight section followed by a first curved section, said first transition section is disposed between the forearm support section and a connecting section;
s.said connecting section is substantially straight throughout a substantial portion of its length, said connecting section extends from the first transition section to a handgrip section, said connecting section extends generally along the length of the forearm from the outside portion of the forearm to a connecting location that is generally adjacent to a thumb side portion of a hand associated with the forearm when the thumb side portion of hand is anterior to the palm section of the hand as the hand grips the handgrip section;
t.said handgrip section comprises a second curved section, a medial section that is substantially straight throughout a substantial portion of its length, and a third curved section, said medial section extends downwardly from the second curved section to the third curved section, and said third curved section extends to a base section; and
u.said base section is substantially straight throughout a substantial portion of its length and extends from the second curved section to the second end of the elongated element.

26. The mobility device for enhancing movement of a user limited by illness or injury of claim 25, wherein each of the first curved section, the second curved section and the third curved section has the predetermined radius of curvature.

27. The mobility device for enhancing movement of a user limited by illness or injury of claim 25, wherein the base section is vertically disposed during stationary support of the user.
